(19) United States
(12) Patent Application Publication
(10) Pub. No.: US 2024/0351507 A1
(43) Pub. Date: Oct. 24, 2024

(54) APPARATUS, SYSTEM, AND METHOD FOR OVER-THE-WHEEL TIE DOWN

(71) Applicant: Auto Strap Chock, LLC, Cave Creek, AZ (US)

(72) Inventor: Darwin Rankin, Glendale, AZ (US)

(21) Appl. No.: 18/629,807

(22) Filed: Apr. 8, 2024

Related U.S. Application Data
(60) Provisional application No. 63/461,264, filed on Sep. 28, 2023.
(60) Provisional application No. 63/461,467, filed on Apr. 24, 2023.

(51) Int. Cl. B60P 3/077

(52) U.S. Cl. CPC B60P 3/077

(57) ABSTRACT

Apparatuses, systems, and methods include a wheel chock for an over-the-wheel tie down system, including a body having an angled portion, a base portion, a first tab, and a second tab. The angled portion is configured to contact a tire when the wheel chock is in use. The base portion extends longitudinally from the angled portion whereby the body is configured to be mounted to a mounting surface. The first tab and the second tab extend from the angled portion and are laterally spaced apart from one another. The wheel chock further includes a rod extending laterally between and to the first tab and the second tab whereby a tie-down strap engages the wheel chock. The body can be formed as a single, monolithic piece. In various embodiments, a support post extends between the angled portion and the base portion.

### CROSS REFERENCE TO RELATED APPLICATIONS

This application claims priority to, and the benefit of, U.S. Provisional Patent Application Ser. No. 63/461,467, entitled “TURBULENCE E BLOCK,” filed on Apr. 24, 2023 and U.S. Provisional Patent Application Ser. No. 63/461,264, filed on Sep. 28, 2023. The foregoing applications are hereby incorporated by reference in their entirety (except for any subject matter disclaimers or disavowals, and except to the extent of any conflict with the disclosure of the present application, in which case the disclosure of the present application shall control).

### FIELD

The present disclosure relates to a wheel chock assembly which secures a vehicle to a tow vehicle (e.g., truck, trailer, train, boat, etc.) by which the vehicle is being transported and, more particularly, to over-the-wheel tie down apparatus and systems.

### BACKGROUND

Thousands of vehicles are shipped across land, sea, and air every day. It is desirable to secure these vehicles safely to a support structure to minimize movement of the vehicles with respect to the support structure during transit, for example to prevent damage to the vehicle and adjacent structures, among other reasons. In order to prevent vehicles from moving or shifting during transportation, tie down systems may be utilized to secure the vehicle that is being transported with respect to the support structure. For example, a vehicle may be held with tie downs in a container or on a trailer, the floor of which can be provided with various types of mounting rails for securing the vehicle tires at various longitudinal locations along the rail. Various types of tie-down systems exist including over-the-tire, through-the-tire, among other systems. Many conventional systems are complex, heavy, and/or cumbersome to operate. Other systems may be simple and/or lightweight but fail to properly secure the vehicle from shifting during transit.

Accordingly, there is a need for simple, user-friendly, lightweight apparatus, systems and/or methods for securing a tire to a support structure that is subject to sudden movements and/or vibrations.

### SUMMARY

In general, one aspect of the subject matter described in this disclosure may be embodied in a wheel chock for an over-the-wheel tie down system. The wheel chock includes a body including an angled portion, a base portion, a first tab, and a second tab. The angled portion is configured to contact a tire when the wheel chock is in use. The base portion extends longitudinally from the angled portion whereby the body is configured to be mounted to a mounting surface. The first tab extends from the angled portion. The second tab extends from the angled portion and is laterally spaced apart from the first tab. The wheel chock further includes a rod extending laterally between and to the first tab and the second tab.

These and other embodiments may optionally include one or more of the following features. The wheel chock can be configured to receive a tie-down strap laterally between the first tab and the second tab and longitudinally between the rod and the angled portion. The base portion can be oriented at a first angle with respect to the angled portion. The first angle can be between thirty-five degrees and sixty-five degrees. The body can be made from a metal plate. The body can be made from a hard rubber material. The angled portion can define an aperture. The base portion can be a tab cut and bent away from the angled portion to form the aperture. The wheel chock can further include an aperture disposed in the base portion whereby the body is configured to be secured to the mounting surface. In use, the wheel chock can be configured to transfer tie-down strap forces from a tie-down strap into the rod, from the rod into the first tab and the second tab, from the first tab and the second tab into the angled portion, and from the angled portion into the tire. The base portion can extend from a first end of the angled portion. The first tab can extend from a second end of the angled portion. The second tab can extend from the second end of the angled portion. The body can further include a support post extending between and to the angled portion and the base portion.

In another aspect, the subject matter may be embodied in an over-the-wheel tie down system. The over-the-wheel tie down system can include a first tie-down bracket configured to be secured at a first side of a tire. The over-the-wheel tie down system can further include a tie-down ratchet configured to be secured at a second side of the tire. The over-the-wheel tie down system can further include a wheel chock configured to be secured at the second side of the tire between the tire and the tie-down ratchet. The over-the-wheel tie down system can further include a tie-down strap configured to extend from the first tie-down bracket, over the tire, through a portion of the wheel chock, and to the tie-down ratchet. The wheel chock can include a body having an angled portion, a base portion, a first tab, and a second tab. The angled portion is configured to contact the tire when the tie-down strap is pulled taut by the tie-down ratchet. The base portion extends longitudinally from the angled portion whereby the body is configured to be mounted to a mounting surface. The first tab extends from the angled portion. The second tab extends from the angled portion and is laterally spaced apart from the first tab. The wheel chock further includes a rod extending laterally between and to the first tab and the second tab, the rod is configured to engage the tie-down strap.

These and other embodiments may include one or more of the following features. The tie-down strap can be configured to pull the tire against the angled portion of the wheel chock. A first end of the angled portion can be located vertically from a second end of the angled portion. The base portion can extend from the first end of the angled portion and the first and second tabs can extend from the second end of the angled portion. The rod can be disposed vertically from the base portion when the wheel chock is in an installed position. A first portion of the tie-down strap can be configured to extend from the rod in a first direction toward the tire and a second portion of the tie-down strap can be configured to extend from the rod in a second direction toward the tie-down ratchet. The first portion can be oriented at a non-parallel angle with respect to the second portion. The system can further include a support post extending between and to the angled portion and the base portion.

In another aspect, the subject matter may be embodied in a method of manufacturing a wheel chock. The method includes cutting a wheel chock blank from a piece of sheet metal, the wheel chock blank includes a first side tab, a second side tab, and a center tab cut from a center body portion of the blank. The method further includes bending the first side tab of the blank about a first bend axis. The method further includes bending the second side tab of the blank about a second bend axis. The method further includes bending the center tab of the blank about a third bend axis.

These and other embodiments may include one or more of the following features. The method can further include coupling a rod to extend between and to the first side tab and the second side tab. The method can further include coupling a support rod to extend between and to an angled portion of the blank to the center tab. The method can further include coupling a nut fastener to the support rod prior to coupling the support rod to the angled portion.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1 is a side view of an over-the-wheel tie down system according to an embodiment of the present disclosure;

FIG. 2 is an enlarged perspective view of the wheel chock of the tie down system of FIG. 1 according to an embodiment of the present disclosure;

FIG. 3 is a side view of the wheel chock mounted to a track fitting according to an embodiment of the present disclosure;

FIG. 4A and FIG. 4B are front and perspective views, respectively, of a wheel chock according to an embodiment of the present disclosure;

FIG. 5 is a schematic assembly view of a wheel, a tie down strap, a wheel chock, a track fitting, and a track according to an embodiment of the present disclosure;

FIG. 6A and FIG. 6B are schematic assembly and side views, respectively of a wheel, a tie down strap, a wheel chock, a track fitting, and a track according to an embodiment of the present disclosure;

FIG. 7A, FIG. 7B, FIG. 7C, and FIG. 7D are perspective, side, front, and rear views, respectively, of a wheel chock according to an embodiment of the present disclosure;

FIG. 8 is a side view of a wheel chock mounted to a support surface according to an embodiment of the present disclosure;

FIG. 9 is a perspective view of a wheel chock installed onto a vertical type E-track according to an embodiment of the present disclosure;

FIG. 10 is a perspective view of a wheel chock installed onto a horizontal type E-track according to an embodiment of the present disclosure;

FIG. 11 is a perspective view of a wheel chock installed onto an L-track according to an embodiment of the present disclosure;

FIG. 12 is a flow chart for a method for manufacturing a wheel chock according to an embodiment of the present disclosure; and

FIG. 13 is a plan view of a wheel chock blank during manufacture of a wheel chock according to an embodiment of the present disclosure.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

The present disclosure describes apparatuses, systems, and methods for over-the-wheel tie down systems. For instance, a tie down system includes a wheel chock configured to receive a tie-down strap therethrough for securing a wheel to a transport vehicle (e.g., a truck, a tractor, a trailer, a boat, an aircraft, a train, etc.). In various embodiments, the over-the-wheel tie down system includes a first tie-down bracket configured to be secured at a first side of a tire, a tie-down ratchet configured to be secured at a second side of the tire, and a wheel chock configured to be secured at the second side of the tire between the tire and the tie-down ratchet. The tie-down strap can be configured to extend from the first tie-down bracket, over the tire, through a portion of the wheel chock, and to the tie-down ratchet.

In various embodiments, the wheel chock has a body having an angled portion, a base portion, a first tab, and a second tab. The angled portion, in various embodiments, is configured to contact the tire when the tie-down strap is pulled taut by the tie-down ratchet. The base portion, in various embodiments, extends longitudinally from the angled portion whereby the body can be mounted to a mounting surface. The first tab, in various embodiments, extends from the angled portion and the second tab, in various embodiments, extends from the angled portion and is laterally spaced apart from the first tab. The wheel chock, in various embodiments, further includes a rod extending laterally between and to the first tab and the second tab. The rod, in various embodiments, is configured to engage the tie-down strap.

In various embodiments, the wheel chock can further include a support post extending between and to the angled portion and the base portion to increase a rigidity of the wheel chock. The support rod can also serve as the fastener by which the wheel chock is fastened to the mounting surface.

In various embodiments, a wheel chock of the present disclosure provides a simple, lightweight, and easy-to-use system for securing a vehicle during transit. The wheel chock 104 can be quickly moved between various longitudinal positions along a track to accommodate tires of various sizes and/or to position a vehicle at a desired longitudinal location. Moreover, as described herein, a wheel chock design of the present disclosure can be manufactured relatively quickly utilizing a cutting process and a subsequent bending process. The wheel chock can be formed as a monolithic structure thereby increasing robustness and manufacturability of the wheel chock.

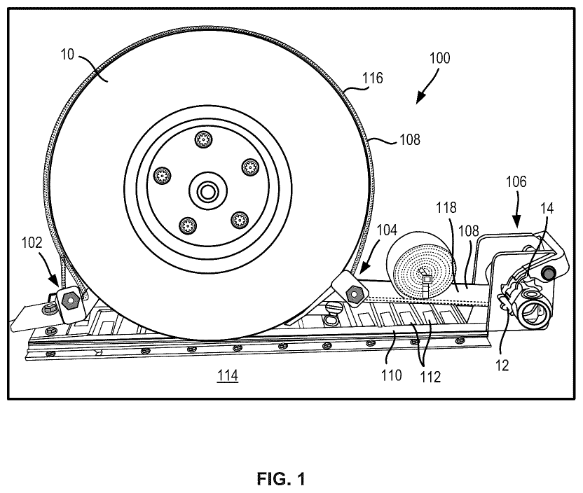

Referring to the drawings, wherein like reference numbers correspond to like or similar components throughout the various figures, FIG. 1 generally shows an over-the-wheel tie down system 100 installed over a tire 10 (e.g., a tire mounted to a wheel and associated vehicle), in accordance with various embodiments. System 100 generally includes a first tie-down bracket 102, a wheel chock 104, a tie-down ratchet 106, and a tie-down strap 108. System 100 can further include a track 110 (e.g., an E-track, L-track, etc.) having a plurality of attachment points 112 disposed along the length thereof for securing the first tie-down bracket 102, the wheel chock 104, and/or the tie-down ratchet 106 to a support surface 114, such as a trailer bed, a truck bed, the ground, or any other surface on which the tire 10 is supported.

The first tie-down bracket 102 can be secured at a first side of the tire 10. The wheel chock 104 can be secured at a second side of the tire 10, opposite the first side. The tie-down ratchet 106 can be secured at the second side of the tire 10 and spaced apart from the wheel chock 104 such that the wheel chock 104 is disposed between the tire 10 and the tie-down ratchet 106. The tie-down strap 108 can be configured to extend from the first tie-down bracket 102, over the tire 10, through a portion of the wheel chock 104, and to the tie-down ratchet 106. In this regard, a first portion 116 of the strap 108 can extend over the tire 10 and between and to the first tie-down bracket 102 and the wheel chock 104 and a second portion 118 of the strap 108 can extend between and to the wheel chock 104 and the tie-down ratchet 106.

The wheel chock 104 can be positioned between the tire 10 and a support surface (e.g., the track 110). The tie down strap 108 can be positioned to extend through a portion of the wheel chock 104 and between and to the first tie-down bracket 102 and the tie-down ratchet 106. The tie-down ratchet 106 can be used to tighten the tie-down strap 108 and pull the tire 10 against an angled portion of the wheel chock 104 with the tie-down strap 108. The wheel chock 104 can be wedge shaped.

In various embodiments, the tie-down ratchet 106 is a hand-driven (or tool-driven) ratchet including a ratchet mechanism 12 (e.g., a toothed wheel) to stop the ratchet 106 from unspooling. The rachet 106 can include a pawl 14 that can be lifted to release a controllable amount of strap length as desired. However, any type of strap tightening device can be used without departing from the scope of the present disclosure, including an electromechanically actuated winch, a ratchet strap, etc.

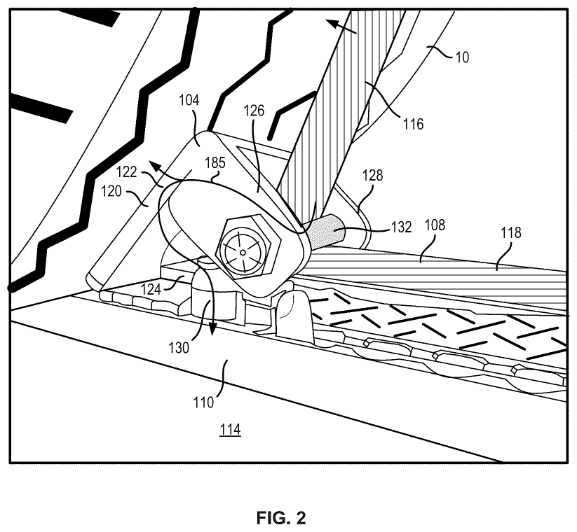

With reference to FIG. 2, an enlarged perspective view of the wheel chock 104 in an installed position is illustrated, in accordance with various embodiments. The wheel chock 104 can be wedge shaped to fit at least partially under the tire and provide a stopping surface to mitigate and/or eliminate rolling movement of the tire 10 with respect to the wheel chock 104. The tie-down system 100 can prevent the tire 10 from moving in any direction with respect to the track and/or mounting surface while also tending to limit the undesirable effects from turbulence experienced during transit. The wheel chock 104 can be removably coupled to the track 110 and placed partially under the tire 10 so as to create a wedge against which the tire 10 can rest while being transported. In various embodiments, the wheel chock 104 can be welded to the track 110. The wheel chock 104 can include a body 120 including an angled portion 122, a base portion 124, a first tab 126, and a second tab 128. The angled portion 122 is configured to contact the tire 10 when the wheel chock 104 is in use. The base portion 124 extends longitudinally from the angled portion 122 whereby the body 120 is configured to be mounted to a mounting surface, such as a track fitting 130. The first tab 126 extends from a first side of the angled portion 122. The second tab 128 extends from a second side of the angled portion 122. In this manner, the first tab 126 is laterally spaced apart from the second tab 128.

A rod 132 extends laterally between and to the first tab 126 and the second tab 128. In various embodiments, the rod 132 is a bolt extending through the first tab 126 and the second tab 128 and secured to the body 120 with a nut fastener. The strap 108 extends between the rod 132 and the angled portion 122. The wheel chock 104 is configured to receive the strap 108 laterally between the first tab 126 and the second tab 128. The wheel chock 104 is configured to receive the strap 108 longitudinally between the rod 132 and the angled portion 122. With the wheel chock 104 secured to the track 110, the strap 108 can be tightened with the tie-down ratchet 106 and pulled taut across the rod 132 to apply a compressive force to the tire 10 to secure the tire 10 in place. The tie-down strap 108 can be configured to pull the tire 10 against the angled portion 122 of the wheel chock 104 when the strap 108 is pulled taut and tightened. The strap 108 can slide against the rod 132 as the strap 108 is tightened. Accordingly, the rod 132 can define a generally smooth outer surface to facilitate the sliding of the strap 108 thereagainst. In various embodiments, tightening the strap 108 pulls the tire 10 against the angled portion 122. The first portion 116 of the strap 108 can extend between and to the rod 132 and the tire 10. The second portion 118 of the strap 108 can extend between and to the rod 132 and the tie-down ratchet 106 (see FIG. 1). The first portion 116 can extend from the rod 132 at a non-parallel angle with respect to the second portion 118. The second portion 118 can extend generally horizontally (e.g., substantially parallel with the track) between the rod 132 and the tie-down ratchet 106.

In use, the wheel chock 104 can be configured to transfer tie-down strap forces from the tie-down strap 108 into the rod 132, from the rod into the first tab 126 and the second tab 128, from the first tab 126 and the second tab 128 into the angled portion 122, and from the angled portion 122 into the tire 10 and/or the base portion 124, the track fitting 130, the track 110 and the support surface 114, as illustrated by arrows 185. The first portion 116 of the tie down strap 108 can also transfer tie-down strap forces directly to the tire 10, as illustrated by arrow 186.

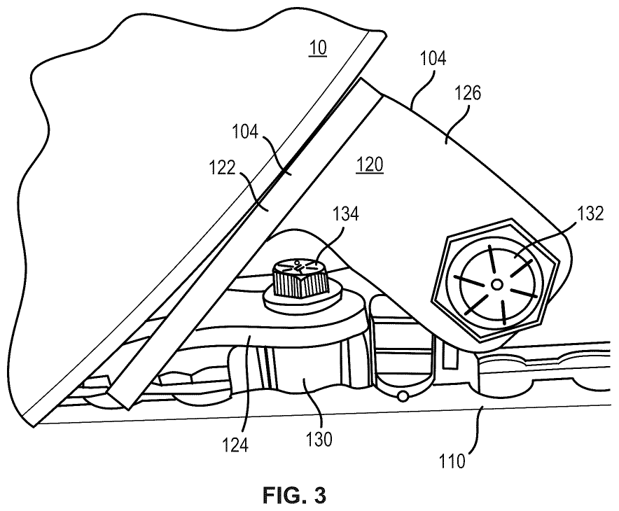

With reference to FIG. 3, the body 120 of the wheel chock 104 can be coupled to the track fitting 130 via a fastener 134, such as a bolt for example. The fastener 134 can extend through the base portion 124 and into the track fitting 130. The fastener 134 can threadingly abut the track fitting 130 (e.g., the track fitting 130 can have a threaded aperture configured to threadingly receive the fastener 134).

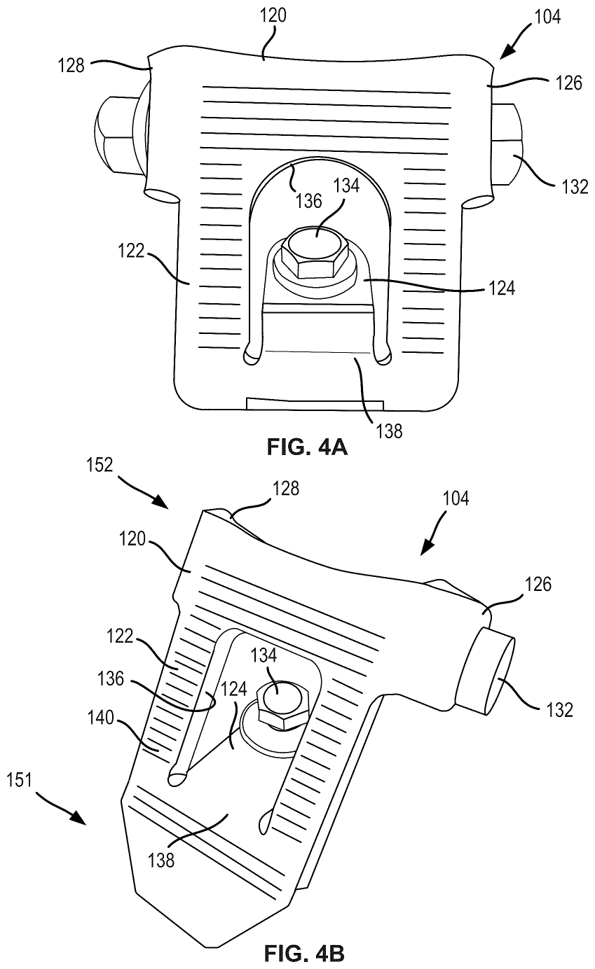

FIG. 4A and FIG. 4B are front and perspective views, respectively, of the wheel chock 104, in accordance with various embodiments. In various embodiments, the angled portion 122 includes a cutout 136 defining an aperture in the angled portion 122 from which the base portion 124 is cut. For example, the base portion 124 can be cut from the angled portion 122 and subsequently bent into place to create an intersection 138 between the angled portion 122 and the base portion 124 at an edge of the cutout 136.

In various embodiments, an exterior surface 140 of the angled portion 122 can be textured to increase friction between the tire 10 (see FIG. 1) and the angled portion 122. In various embodiments, the exterior surface 140 is a planar surface. In various embodiments, the exterior surface 140 could also be concave to complement the round shape of the tire.

The base portion 124 can extend from a first end 151 of the angled portion 122. The first tab 126 can extend from a second end 152 of the angled portion 122. The second tab 128 can extend from the second end 152 of the angled portion 122.

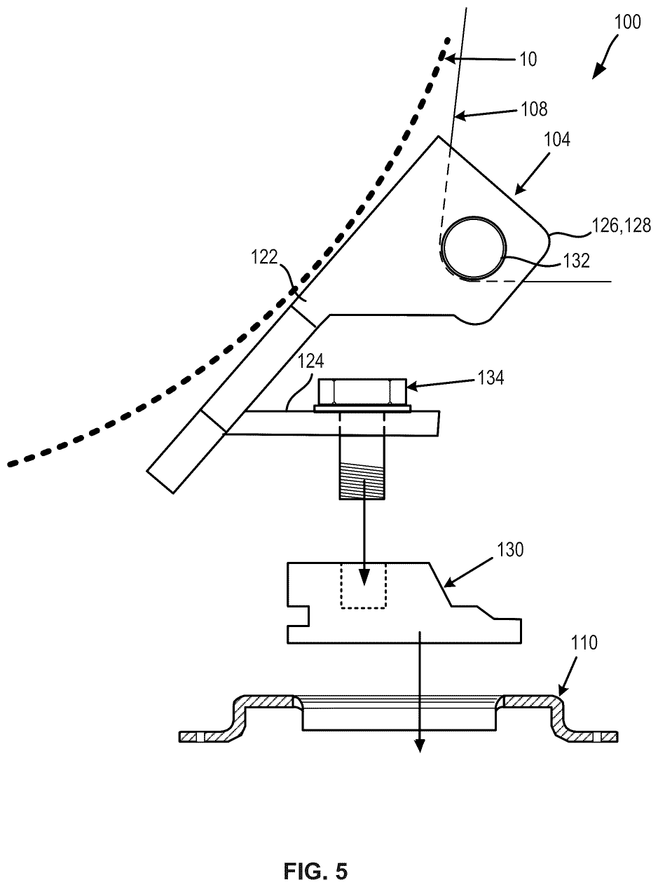

FIG. 5 is an assembly view of the system 100 at the wheel chock 104, in accordance with various embodiments. In various embodiments, the base portion 124 is cantilevered from the angled portion 122. However, in accordance with various embodiments, the fastener 134 can be replaced with a support post that extends from the base portion 124 and the angled portion 122, as described further below.

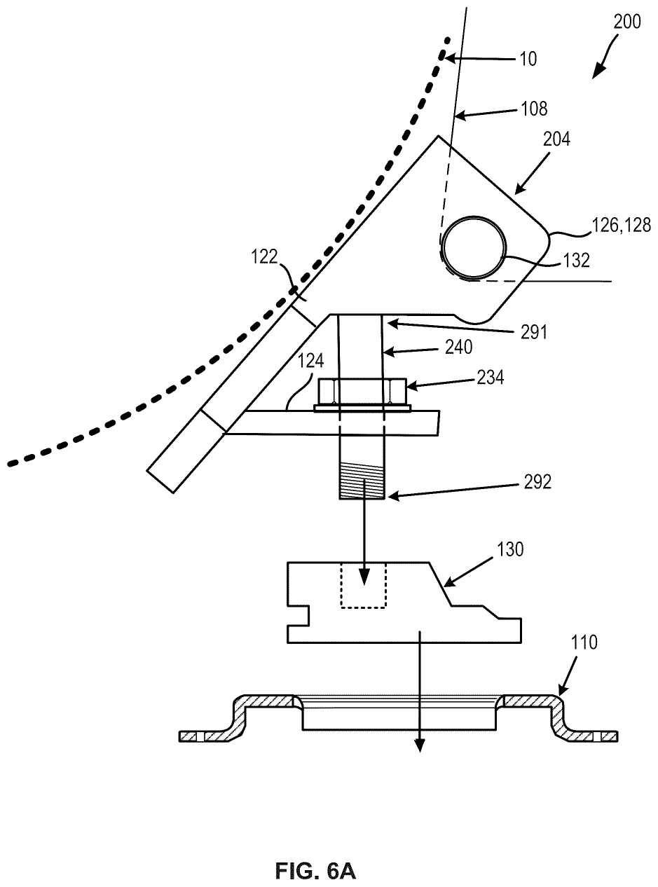

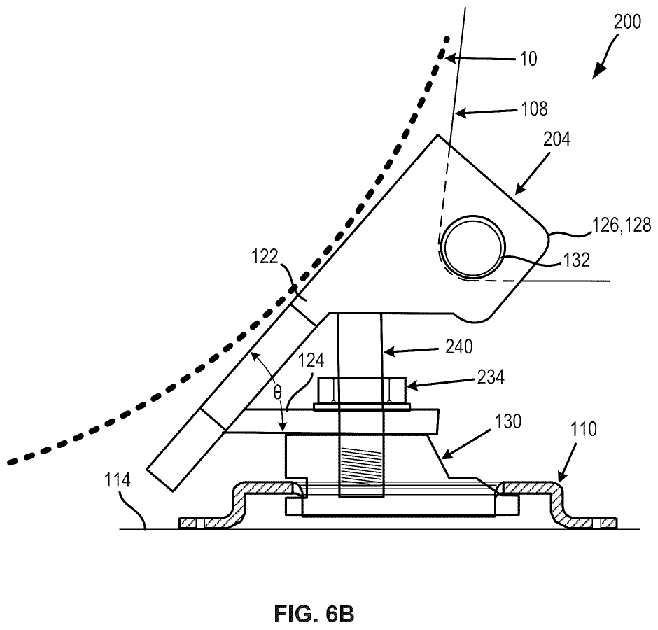

FIG. 6A is an assembly view of a system 200, in accordance with various embodiments. The system 200 can be similar to system 100 of FIG. 5, except that the wheel chock 204 further includes a support post 240 extending between and to the base portion 124 and the angled portion 122. With respect to FIG. 6A, elements with like element numbering, as depicted in FIG. 5, are intended to be the same and will not necessarily be repeated for the sake of clarity. The support post 240 can extend through the base portion 124. In various embodiments, a first end 291 of the support post 240 can be joined to the angled portion 122 via a metal joining process, such as welding, brazing, soldering, or the like. In various embodiments, a second end 292 of the support post 240 can be configured to be received by the track fitting 130. A nut fastener 234 can be threadingly coupled to the support post 240 at a location between the angled portion 122 and the base portion 124. For example, the nut fastener 234 can be placed over the support post 240 before the support post is welded to the angled portion 122. The support post 240 can be a threaded fastener, a threaded rod, or the like. The nut fastener 234 can be tightened against the base portion 124 to stop the base portion 124 from bending toward the angled portion 122 when the strap 108 is tightened over a tire. In this manner, the support post 240 can increase the stiffness of the wheel chock 204. In various embodiments, tightening the nut fastener 134 against the base portion 124 can increase an angle between the base portion 124 and the angled portion 122.

FIG. 6B is an assembled view of the system 200 of FIG. 6A. It should be understood that the shape of the track fitting 130 and the track 110 can vary depending on the type of track 110 being used with the wheel chock 204. Moreover, the particular manner in which the track fitting 130 connects to the track 110 can vary depending on the type of track 110 being used with the wheel chock 204. The angled portion 122 can be oriented at an angle θ with respect to the base portion 124. The angle θ can be between thirty degrees and sixty degrees in various embodiments, between thirty-five degrees and sixty-five degrees in various embodiments, or between forty degrees and fifty degrees in various embodiments. In the install position, the base portion 124 can be oriented generally horizontally (e.g., parallel to the support surface 114).

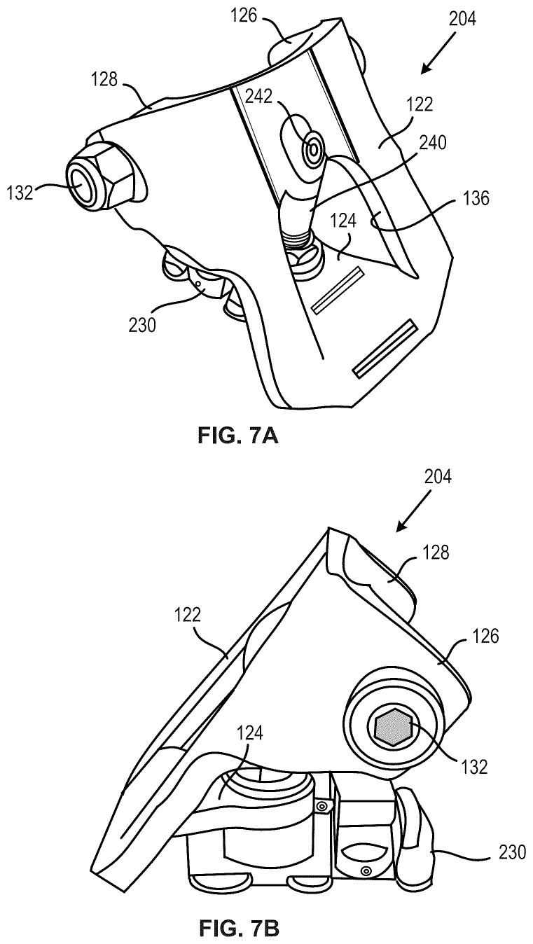

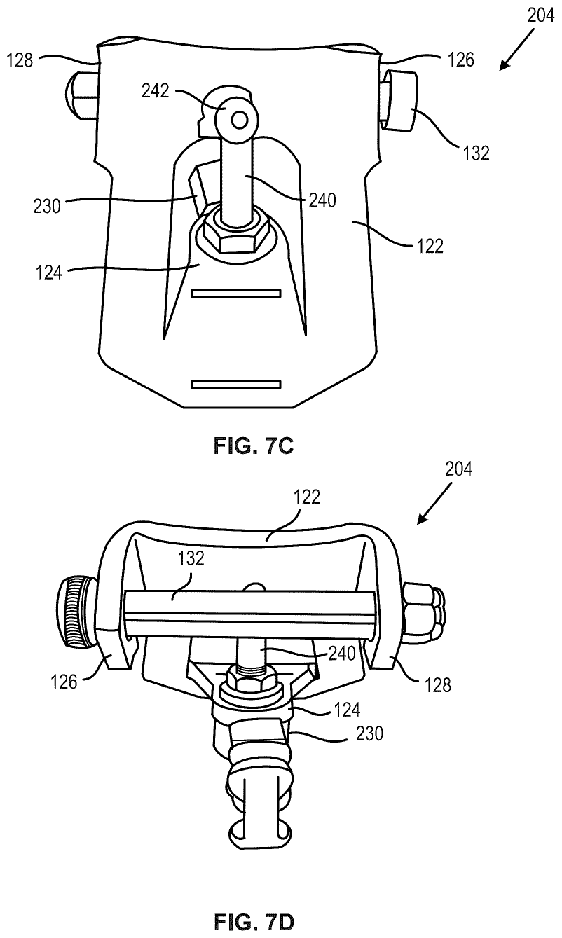

With reference to FIG. 7A, FIG. 7B, FIG. 7C, and FIG. 7D, the wheel chock 204 is illustrated coupled to a track fitting 230. The track fitting 230 can be similar to track fitting 130 (see FIG. 6B) in accordance with various embodiments. A weld 242 can be located at the top of the cutout 136 whereby the support post 240 is attached to the angled portion 122.

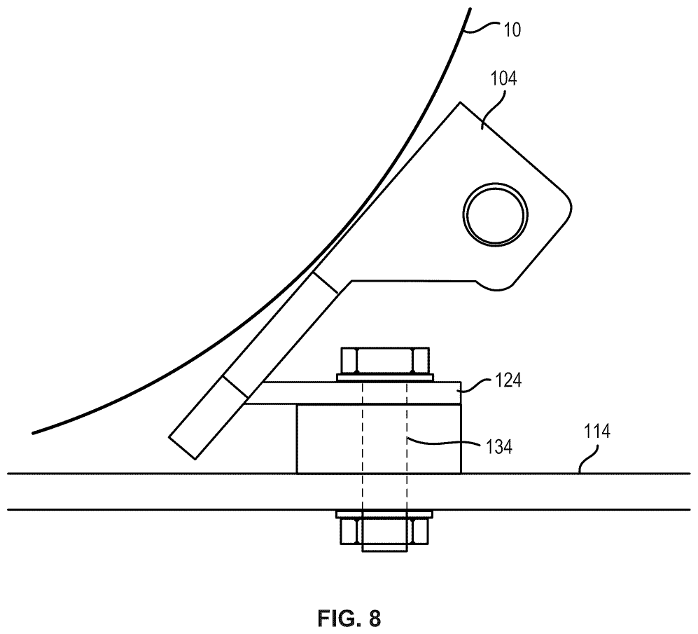

With reference to FIG. 8, the wheel chock 104 can be coupled to the support surface 114 without a track. For example, a fastener 134 can secure the base portion 124 to the support surface 114.

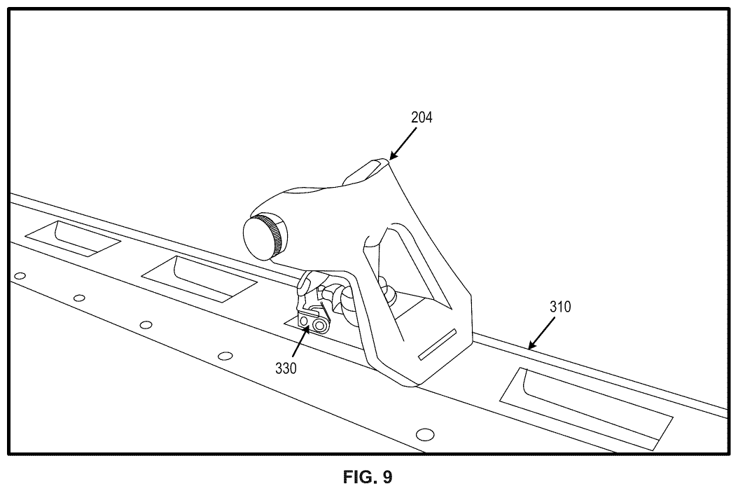

With reference to FIG. 9, a wheel chock 204 is illustrated installed into a vertical type E-track 310 via a vertical type E-track fitting 330.

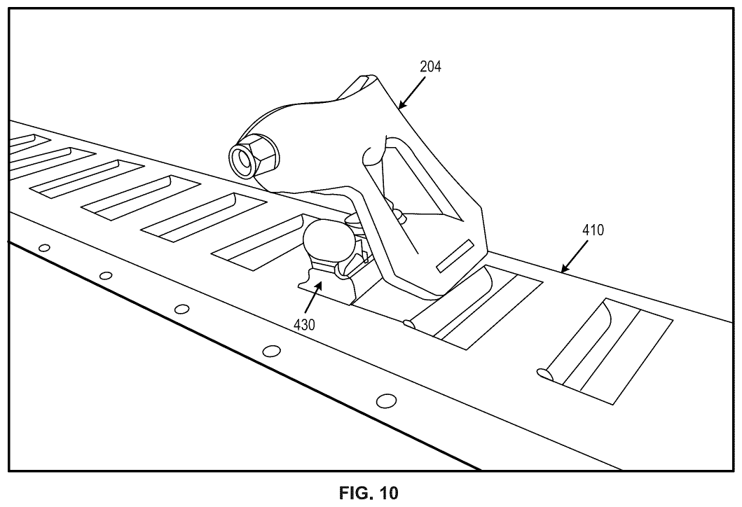

With reference to FIG. 10, a wheel chock 204 is illustrated installed into a horizontal type E-track 410 via a horizontal type E-track fitting 430.

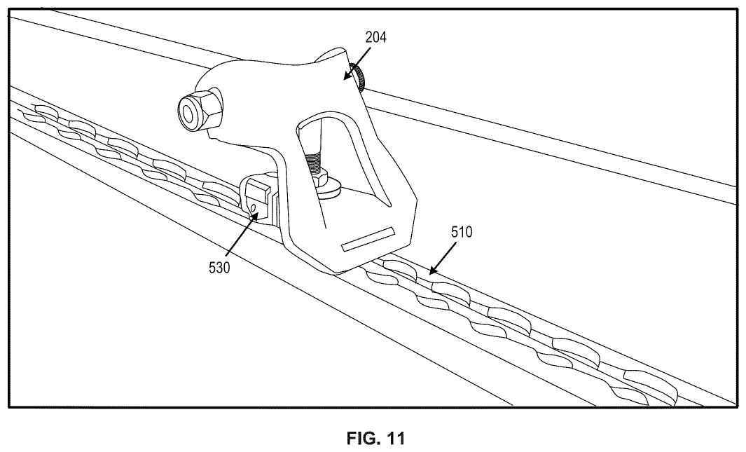

With reference to FIG. 11, a wheel chock 204 is illustrated installed into an L-track 510 via an L-track fitting 530.

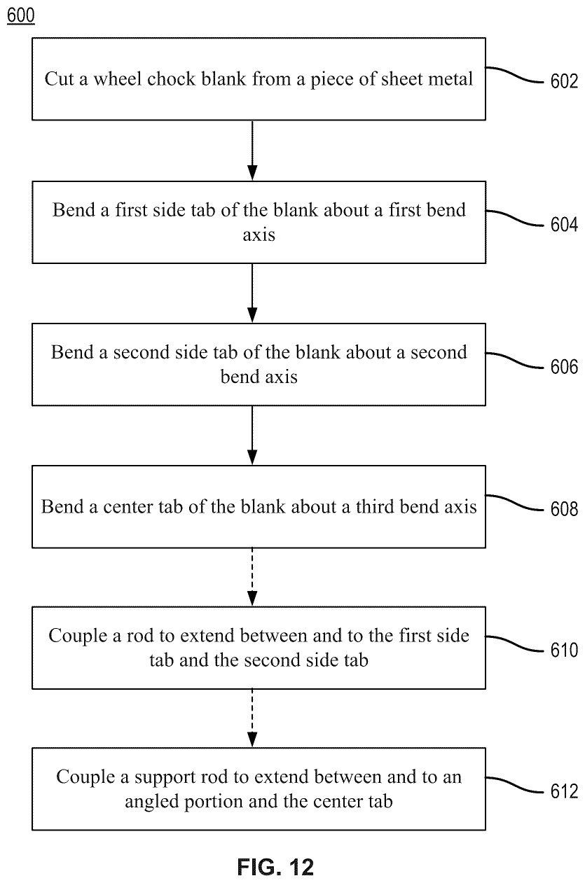

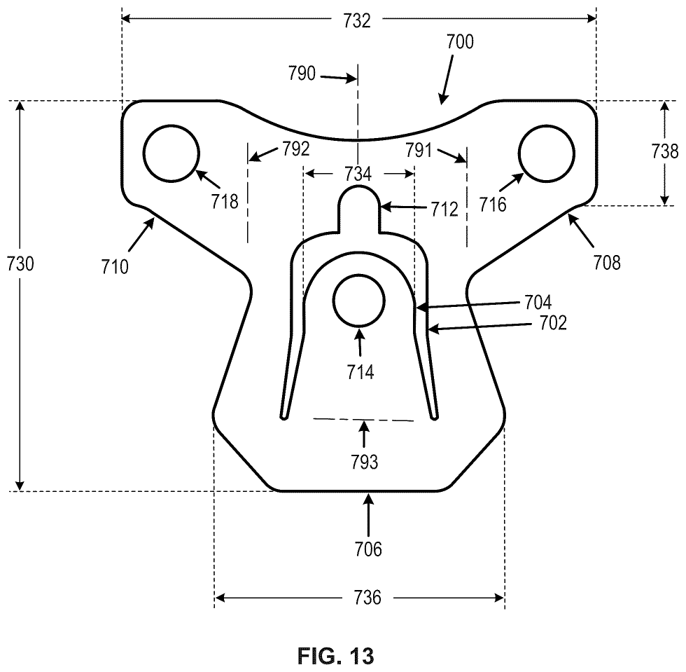

With reference to FIG. 12, a flowchart illustrating a method 600 of manufacturing a wheel chock is provided, in accordance with various embodiments. For ease of description, the method 600 is described below with reference to FIG. 7A and FIG. 13. The method 600 of the present disclosure, however, is not limited to use of the example wheel chock 204 of FIG. 7A or the example wheel chock blank 700 of FIG. 13.

In step 602, the method 600 includes cutting a wheel chock blank 700 from a piece of sheet metal or metal plate. For example, wheel chock blank 700 can be cut to shape using a waterjet process, a plasma process, an EDM process, a laser process, a punch process, or any other suitable method of cutting sheet metal. The wheel chock blank 700 can be a planar sheet of metal. The blank 700 can be generally T-shaped. For example, the blank 700 can have a generally U-shape cutout 702 that forms a center tab 704 extending from a center body portion 706. A first tab 708 can extend from the center body portion 706. A second tab 710 can extend from the center body portion 706. The first tab 708 and the second tab 710 can extend from the center body portion 706 in opposite directions.

In various embodiments, a small groove 712 is cut into the center body portion 706 and extending from the cutout 702. The groove 712 can form a weld location for the support post (e.g., support post 240). The center tab 704 can have an aperture 714 disposed therein. The aperture 714 can be configured to receive a fastener (e.g., the fastener 134 of FIG. 3 and/or the support post 240 of FIG. 7A). The first tab 708 can have an aperture 716 disposed therein. The aperture 716 can be configured to receive a rod (e.g., the rod 132). The second tab 710 can have an aperture 718 disposed therein. The aperture 718 can be configured to receive the rod (e.g., the rod 132). In various embodiments, the aperture 716 and the aperture 718 are the same size. In various embodiments, the blank 700 is symmetric about a center axis 790.

In step 604, the method 600 includes bending the first tab 708 about a bend axis 791. In various embodiments, the bend axis 791 is parallel or nearly parallel (i.e., within ten degrees of parallel) with the center axis 790. For example, the tab 708 can be bent by about ninety degrees. In various embodiments, the tab 708 is bent from its original orientation by between eighty degrees and one hundred degrees. In various embodiments, the tab 708 is bent from its original orientation by between eighty-five degrees and ninety-five degrees. The tab 708 can be bent to form a first tab (e.g., first tab 126).

In step 606, the method 600 includes bending the second tab 710 about a bend axis 792. In various embodiments, the bend axis 792 is parallel or nearly parallel (i.e., within ten degrees of parallel) with the center axis 790. For example, the second tab 710 can be bent by about ninety degrees. In various embodiments, the second tab 710 is bent from its original orientation by between eighty degrees and one hundred degrees. In various embodiments, the second tab 710 is bent from its original orientation by between eighty-five degrees and ninety-five degrees. The tab 710 can be bent to form a second tab (e.g., the second tab 128).

In step 608, the method 600 includes bending the center tab 704 about a bend axis 793. In various embodiments, the bend axis 793 is perpendicular or nearly perpendicular (i.e., within ten degrees of perpendicular) to the center axis 790. For example, the center tab 704 can be bent by about forty-five degrees. In various embodiments, the center tab 704 is bent from its original orientation by between thirty degrees and sixty degrees. In various embodiments, the center tab 704 is bent from its original orientation by between thirty-five degrees and sixty-five degrees. In various embodiments, the center tab 704 is bent from its original orientation by between forty degrees and fifty degrees. The center tab 704 can be bent to form a base portion (e.g., the base portion 124).

In various embodiments, the body 120 of the wheel chock 204 is formed as a single, monolithic piece. For example, formed from a single sheet metal blank through the bending process.

In step 610, the method 600 can further include coupling a rod (e.g., the rod 132) to extend between and to the first side tab 126 and the second side tab 128. For example, the rod 132 can be positioned to extend through the first aperture 716 and the second aperture 718. In various embodiments, step 610 can be performed by a third party or an end user. For example, the body 120 and the rod 132 can be sold together as a kit and an end user can install the rod 132.

In step 612, the method 600 can further include coupling a support post (e.g., the support post 240) to extend between and to the angled portion 122 and the base portion 124. For example, the support post 240 can be positioned to extend through the aperture 714. The support post 240 can be welded to the center body portion 706 (now referred to as the angled portion 122) at the groove 712. In various embodiments, step 612 is omitted.

In various embodiments, and with reference to FIG. 13, an overall length 730 of the blank 700 can be about 3.7 inches (9.4 cm). The overall length 730 can be between 3 inches (7.6 cm) and 8 inches (20.3 cm) depending on the size tire intended for the wheel chock. In various embodiments, the overall width 732 of the blank 700 measured before the first tab 708 and the second tab 710 are bent can be about 4.5 inches (11.4 cm). The overall width 732 can be between 3 inches (7.6 cm) and 8 inches (20.3 cm) depending on the size tire intended for the wheel chock. The width 734 of the center tab 704 can be about 1 inch (2.54 cm). The width of the center tab 704 can be between 0.75 inches (1.9 cm) and 3 inches (7.62 cm) depending on the size tire intended for the wheel chock. In various embodiments, an overall width 736 of the center body portion 706 can be about 2.75 inches (7 cm). The overall width 736 can be between 2 inches (5 cm) and 8 inches (20.3 cm) depending on the size tire intended for the wheel chock. In various embodiments, a length 738 of the first side tab 708 (and similarly the second side tab 710) can be about 1 inch (2.54 cm). The overall length 738 can be between 0.5 inches 1.2 cm) and 4 inches (10 cm) depending on the size tire intended for the wheel chock.

In various embodiments, a thickness of the blank 700 can be between 0.1875 inch and 0.5 inch (4.7625 mm to 12.7 mm). The thickness of the blank 700 can be consistent across the entire sheet. The blank 700 can be a steel plate, such as ASTM A36 steel or the like. In various embodiments, the blank 700 can be made from iron, steel, stainless steel, aluminum, titanium, nickel, and/or alloys thereof. In various embodiments, the blank 700 can be made from a composite material, such as a fiber-reinforced carbon composite.

In various embodiments, the body 120 of the wheel chock 204 is a hard rubber material, such as styrene-butadiene rubber (SBR), among others. For example, the body 120 can be manufactured using an additive manufacturing process (e.g., 3D printing), a negative manufacturing process (e.g., a milling process, a grinding process, a drilling process, etc.), injection molding, compression molding, or any other suitable method.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

It is understood that relative positional terms such as “forward,” “aft,” “upper,” “lower,” “above,” “below,” and the like are with reference to the normal operational attitude and should not be considered otherwise limiting. It is also understood that like reference numerals identify corresponding or similar elements throughout the several drawings. It should be understood that although a particular component arrangement is disclosed in the illustrated embodiment, other arrangements will also benefit. Although particular step sequences may be shown, described, and claimed, it is understood that steps may be performed in any order, separated or combined unless otherwise indicated and will still benefit from the present disclosure.

What is claimed is:

1. A wheel chock for an over-the-wheel tie down system, the wheel chock comprising:
a body including an angled portion, a base portion, a first tab, and a second tab, the angled portion is configured to contact a tire when the wheel chock is in use, the base portion extends longitudinally from the angled portion whereby the body is configured to be mounted to a mounting surface, the first tab extends from the angled portion, and the second tab extends from the angled portion and is laterally spaced apart from the first tab; and
a rod extending laterally between and to the first tab and the second tab.

2. The wheel chock of claim 1, wherein the wheel chock is configured to receive a tie-down strap laterally between the first tab and the second tab and longitudinally between the rod and the angled portion.

3. The wheel chock of claim 1, wherein the base portion is oriented at a first angle with respect to the angled portion.

4. The wheel chock of claim 3, wherein the first angle is between thirty-five degrees and sixty-five degrees.

5. The wheel chock of claim 1, wherein the body is made from a metal plate.

6. The wheel chock of claim 1, wherein the angled portion defines an aperture, and the base portion is a tab cut and bent away from the angled portion to form the aperture.

7. The wheel chock of claim 1, further comprising an aperture disposed in the base portion whereby the body is configured to be secured to the mounting surface.

8. The wheel chock of claim 1, wherein, in use, the wheel chock is configured to transfer tie-down strap forces from a tie-down strap into the rod, from the rod into the first tab and the second tab, from the first tab and the second tab into the angled portion, and from the angled portion into the tire.

9. The wheel chock of claim 1, wherein the base portion extends from a first end of the angled portion, the first tab extends from a second end of the angled portion, and the second tab extends from the second end of the angled portion.

10. The wheel chock of claim 1, wherein the body further includes a support post extending between and to the angled portion and the base portion.

11. An over-the-wheel tie down system, comprising:
a first tie-down bracket configured to be secured at a first side of a tire;
a tie-down ratchet configured to be secured at a second side of the tire;
a wheel chock configured to be secured at the second side of the tire between the tire and the tie-down ratchet; and
a tie-down strap configured to extend from the first tie-down bracket, over the tire, through a portion of the wheel chock, and to the tie-down ratchet;
wherein the wheel chock comprises:
a body having an angled portion, a base portion, a first tab, and a second tab, the angled portion is configured to contact the tire when the tie-down strap is pulled taut by the tie-down ratchet, the base portion extends longitudinally from the angled portion whereby the body is configured to be mounted to a mounting surface, the first tab extends from the angled portion, and the second tab extends from the angled portion and is laterally spaced apart from the first tab; and
a rod extending laterally between and to the first tab and the second tab, the rod is configured to engage the tie-down strap.

12. The over-the-wheel tie down system of claim 11, wherein the tie-down strap is configured to pull the tire against the angled portion of the wheel chock.

13. The over-the-wheel tie down system of claim 11, wherein a first end of the angled portion is located vertically from a second end of the angled portion, the base portion extends from the first end of the angled portion, and the first tab and the second tab extend from the second end of the angled portion.

14. The over-the-wheel tie down system of claim 13, wherein the rod is disposed vertically from the base portion when the wheel chock is in an installed position.

15. The over-the-wheel tie down system of claim 11, wherein a first portion of the tie-down strap is configured to extend from the rod in a first direction toward the tire and a second portion of the tie-down strap is configured to extend from the rod in a second direction toward the tie-down ratchet, and the first portion is oriented at a non-parallel angle with respect to the second portion.

16. The over-the-wheel tie down system of claim 11, further comprising a support post extending between and to the angled portion and the base portion.

17. A method of manufacturing a wheel chock, comprising:
cutting a wheel chock blank from a piece of sheet metal, the wheel chock blank includes a first side tab, a second side tab, and a center tab cut from a center body portion of the wheel chock blank;
bending the first side tab of the wheel chock blank about a first bend axis;
bending the second side tab of the wheel chock blank about a second bend axis; and
bending the center tab of the wheel chock blank about a third bend axis.

18. The method of claim 17, further comprising coupling a rod to extend between and to the first side tab and the second side tab.

19. The method of claim 17, further comprising a support rod to extend between and to an angled portion of the wheel chock blank to the center tab.

20. The method of claim 19, further comprising coupling a nut fastener to the support rod prior to coupling the support rod to the angled portion.
